(19) United States
(12) Patent Application Publication
(10) Pub. No.: US 2024/0034650 A1
(43) Pub. Date: Feb. 1, 2024

(54) METHOD AND SYSTEM FOR CLARIFYING WATER

(71) Applicant: CLEARFLOW GROUP INC., Sherwood Park (CA)

(72) Inventor: Gerald Hanna, Sherwood Park (CA)

(73) Assignee: CLEARFLOW GROUP INC., Sherwood Park (CA)

(21) Appl. No.: 18/226,648

(22) Filed: Jul. 26, 2023

Related U.S. Application Data
(60) Provisional application No. 63/392,856, filed on Jul. 27, 2022.

(51) Int. Cl. C02F 1/56; C02F 1/52; B01D 21/01; B01D 21/00

(52) U.S. Cl. CPC C02F 1/56; C02F 1/5236; C02F 1/5281; B01D 21/01; B01D 21/0018; B01D 21/0051; C02F 2001/007

(57) ABSTRACT

A method and system are provided for clarifying water by passing water through one or more reactor canisters having a flow-through cartridge containing a composition for flocculating or settling solids suspended in the water. After passing through the reactor canisters, the water flows into a primary settling tank to allow solids to precipitate therefrom. The water then flows over a weir into a secondary settling tank to allow further precipitation of suspended solids remaining in the water. The water can then pass through tubular settling media to aid in further precipitation of solids therefrom, and then flow into an outlet chamber where the now clarified water can be withdrawn.

### CROSS-REFERENCE TO RELATED APPLICATIONS

This application claims priority of U.S. Provisional Patent Application Ser. No. 63/392,856 filed Jul. 27, 2022, which is incorporated by reference into this application in its entirety.

### TECHNICAL FIELD

The present disclosure is related to the field of systems for clarifying water, in particular, methods and systems comprising flocculant reactors and settling tanks.

### BACKGROUND

Water and liquids used in construction, industrial, mining and well drilling operations can contain suspended solids after being used. In some instances, governmental laws and regulations can require that the removal of the suspended solids must be carried out before the water or liquids can be introduced into the environment. In other instances, the recovery of the liquids, once the solids have been removed, can reduce the costs of the operation by re-using the liquids instead of discarding the liquids and using new or fresh liquids at a higher cost.

Wastewater and sewage can contain suspended solids. In some instances, governmental laws and regulations can require that the removal of the suspended solids must be carried out before the water or liquids can be introduced into the environment. In other instances, the recovery of the liquids, once the solids have been removed, can reduce the costs of the operation by re-using the liquids instead of discarding the liquids and using new or fresh liquids at a higher cost.

U.S. Pat. No. 3,085,916 issued to Zimmie et al. on Apr. 16, 1963 describes a method of flocculating and preventing the accumulation of solids or silt in cooling systems by introducing water-soluble polyelectrolytic organic polymers into aqueous cooling systems.

U.S. Pat. No. 3,860,526 issued to Corbett on Jan. 14, 1975 describes a solid flocculant that can be placed into an effluent stream or body of water to release flocculant into the stream or water at a controlled rate.

U.S. Pat. No. 5,720,886 issued to Iwinski on Feb. 24, 1998 describes a process for using polymer to remove dissolved and particulate metal from mine wastewater. U.S. Pat. No. 5,795,620 issued to Iwinski on Aug. 18, 1998 describes the coating of waste rock with polymer to retard the leaching of metal from the waste rock.

The shortcomings of the prior art are that they do not provide a cost-effective and efficient method of flocculating or settling of solids suspended in liquids. In addition, the prior art concerning wastewater treatment systems does not provide a cost-effective and efficient method of flocculating or settling of solids suspended in liquids, as these prior art methods and systems can take 2 to 5 weeks to clarify water using microbial reactions.

It is, therefore, desirable to provide a method and system that overcomes the shortcomings of the prior art, and to provide a system and a method of clarifying water and, in some embodiments, sewage in an efficient and cost-effective manner.

### SUMMARY

In some embodiments, a method and system can be provided for clarifying water by passing water through one or more reactor canisters having a flow-through cartridge containing a composition for flocculating or settling solids suspended in the water. After passing through the reactor canisters, the water can flow into a primary settling tank to allow solids to precipitate therefrom. The water can then flow over a weir into a secondary settling tank to allow further precipitation of the remaining solids suspended in the water. The water can then pass through tubular settling media to then flow into an outlet chamber where the water can be withdrawn. Settled solids that accumulate in the bottom of each of the primary and secondary settling tanks can be withdrawn and can be further processed to extract and clarify water contained in the settled solids.

For the purposes of this description and the claims that follow, the term “water” shall be deemed to include any liquid containing suspended solids therein, and not just simply water, and the terms “water” and “liquids” shall be understood as being interchangeable for each other herein.

In some embodiments, a method and system for clarifying water can be provided using a composition disposed in a flow-through cartridge in a reactor canister for flocculating or settling solids suspended in the water, and then passing the water through a settling tank. In some embodiments, the composition can comprise a polymer, an alkaline earth metal soluble salt, and water. In other embodiments, the alkaline earth metal soluble salt can be formed by combining an earth metal salt with a mineral acid or an organic acid. In some embodiments, the composition can be in solid form, in gelatinous form, or a combination of the two. In some embodiments, the composition can be manufactured by first combining the polymer and the alkaline earth metal soluble salt, and then adding the water.

In some embodiments, a cartridge is provided for use in the reactor canister for flocculating or settling solids suspended in liquids. The cartridge can comprise an outer sidewall and inner sidewall wherein the composition can be disposed therebetween. The outer and inner sidewalls can further comprise perforations wherein water flowing around the cartridge can contact the composition through the perforations and cause the composition to dissolve and enter into the water.

In some embodiments, a reactor canister can be provided for flocculating or settling solids suspended in water. The reactor canister can comprise a housing configured to house a cartridge comprising the composition, the reactor canister further comprising an inlet and an outlet wherein water containing suspended solids can enter through the inlet and flow around the cartridge to contact the composition and exit through the outlet.

The advantage of passing water through the reactor canister prior to entering the primary settling tank is that the initial mixing or dosing of the water with a flocculant occurs in the reactor canister, and not in the primary settling tank as is typically done in prior art systems using flocculants and settling tanks. By dosing the water with flocculant as it passes through the reactor canister allows the water to enter the primary settling tank ready for the suspended solids in the water to coagulant and form large enough clumps to begin precipitating out of the water, reducing the amount of time required for the water to be in the primary settling tank as it flows through the system.

In some embodiments, recovered water from oil and gas operations can be pre-processed to screen out heavy oils, solids and sludge to separate oil and oil components from the water. In some embodiments, ozone can be added to the water stream to oxidize light end hydrocarbons such as benzene, toluene, ethylbenzene, xylene (BTEX); and sulphide to elemental sulfur and sulphate. Ozone can be added into the stream through a diffuser or pressure chamber in order to get optimal ozone dissolution in the water stream.

In some embodiments, the water can be processed to remove heavy oils, solids and sludge prior to the implementation of the methods and systems described herein. In some embodiments, the source water can be typically orange-brown in colour and cloudy when coming from a water source. In some embodiments, the methods and systems described herein can be used to treat other water sources including, but not limited to: mine water; process water; surface run-off water; restaurant wastewater; vehicle wash bay wastewater; sewage; work camp wastewater; metal-contaminated water; nutrient-contaminated water; and hydrocarbon-contaminated water.

In some embodiments, ozone can be added near the beginning of the method described herein to oxidize contaminants. In other embodiments, oxygen can be added near the beginning of the method described herein with ozone being added later in the method. In some embodiments, for the purposes of this specification and the claims that follow, hydrogen peroxide can be used in place of ozone or can be used in combination with ozone.

In some embodiments, the system can optionally comprise an H₂S reducer or scrubber to remove hydrogen sulphide from the water if the water is from a sour gas well or from a well that produces hydrogen sulphide before (or after) the water passes through an oil/water separator. In some embodiments, the settled solids withdrawn from one or both of the primary and secondary settling tanks can be passed through at least one centrifuge or hydro-cyclone machine to further separate solids from the water before being passed through a filtration medium.

Broadly stated, in some embodiments, a method can be provided for clarifying water, the method comprising: passing the water through at least one reactor configured for contacting the water with a first composition, wherein the first composition comprises: a first polymer comprising a high molecular weight, in a proportion of approximately 0% to 70% by weight, a first soluble salt of a group IA metal or a first soluble salt of a group IIA metal in a proportion of approximately 0.5% to 50% by weight, and water, in a proportion to make up the balance of 100% weight; then passing the water from the at least one reactor into a primary settling tank; then passing the water from the primary settling tank over a weir into a secondary settling tank; and then passing the water from the secondary settling tank through a tubular settling media onto a trough and then flowing the water into an outlet chamber.

Broadly stated, in some embodiments, the method can further comprise passing the water from the outlet chamber through at least one outlet port.

Broadly stated, in some embodiments, the first composition can be prepared by mixing the first soluble salt of a group IA metal or the first soluble salt of a group IIA metal with the water first, and then adding the first polymer thereto.

Broadly stated, in some embodiments, the method can further comprise contacting the water with a second composition in the primary settling tank, wherein the second composition comprises: a second polymer comprising a high molecular weight, in a proportion of approximately 0% to 70% by weight; a second soluble salt of a group IA metal or a second soluble salt of a group IIA metal in a proportion of approximately 0.5% to 50% by weight; and water, in a proportion to make up the balance of 100% weight.

Broadly stated, in some embodiments, the second composition can be prepared by mixing the second soluble salt of a group IA metal or the second soluble salt of a group IIA metal with the water first, and then adding the second polymer thereto.

Broadly stated, in some embodiments, the second composition can comprise the first composition or a variant of the first composition.

Broadly stated, in some embodiments, the method can further comprise passing the water through a plurality of the at least one reactor.

Broadly stated, in some embodiments, the plurality of the at least one reactor can be configured in one of a parallel configuration and a series configuration.

Broadly stated, in some embodiments, the plurality of the at least one reactor can be configured in a combination of a parallel configuration and a series configuration.

Broadly stated, in some embodiments, the method can further comprise circulating the water in the primary settling tank through an aerating manifold.

Broadly stated, in some embodiments, wherein circulating the water can comprise drawing the water from the primary settling tank with a pump, and then pumping the water into the primary settling through the aerating manifold.

Broadly stated, in some embodiments, a system can be provided for clarifying water, the system comprising: at least one reactor comprising an inlet and an outlet, the at least one reactor configured for contacting the water with a first composition, wherein the first composition comprises: a first polymer comprising a high molecular weight, in a proportion of approximately 0% to 70% by weight, a first soluble salt of a group IA metal or a first soluble salt of a group IIA metal in a proportion of approximately 0.5% to 50% by weight, and water, in a proportion to make up the balance of 100% weight; a primary settling tank operatively coupled to the outlet of the at least one reactor; a secondary settling tank; a weir disposed between the primary and secondary settling tanks, wherein the water flows over the weir from the primary settling tank into the secondary settling tank; and a tubular settling media disposed in the secondary settling tank, wherein the tubular settling media is configured for the water to flow through the tubular settling media from the second settling tank into an outlet chamber.

Broadly stated, in some embodiments, the primary settling tank can comprise an aerating manifold disposed therein, the aerating manifold operatively coupled to a pump configured to pump the water drawn from the primary settling tank into the aerating manifold.

Broadly stated, in some embodiments, the primary settling tank can be configured to suspend a second composition therein, thereby contacting the water with the second composition, wherein the second composition comprises: a second polymer comprising a high molecular weight, in a proportion of approximately 0% to 70% by weight; a second soluble salt of a group IA metal or a second soluble salt of a group IIA metal in a proportion of approximately 0.5% to 50% by weight; and water, in a proportion to make up the balance of 100% weight.

Broadly stated, in some embodiments, the system can further comprise a plurality of the at least one reactor.

### BRIEF DESCRIPTION OF THE DRAWINGS:

FIG. 1 is a side elevation view depicting one embodiment of a system for clarifying water.

FIG. 2 is a right front perspective view depicting the system of FIG. 1.

FIG. 3 is a left rear perspective view depicting the system of FIG. 1.

FIG. 4 is a front perspective view depicting the system of FIG. 1.

FIG. 5 is a front top perspective view depicting the system of FIG. 4.

FIG. 6 is a front right perspective view depicting the system of FIG. 4.

FIG. 7 is a right side perspective view depicting the system of FIG. 6.

FIG. 8 is a left side perspective view depicting the system of FIG. 6.

FIG. 9 is a block diagram depicting the connection configuration of four reactors of FIG. 6.

FIG. 10A is a front left perspective view depicting the system of FIG. 1.

FIG. 10B is a mid-left perspective view depicting the system of FIG. 10A.

FIG. 11 is a block diagram depicting a circulating pump for the system of FIG. 1.

FIG. 12 is a fight side elevation cross-section view depicting the settling tanks of the system of FIG. 1.

FIG. 13 is perspective view depicting a portion of the tube settling media of FIG. 1.

FIG. 14 is a top left perspective view depicting the tube settling media of the system of FIG. 1.

FIG. 15 is a top right perspective view depicting the tube settling media of the system of FIG. 1.

### DETAILED DESCRIPTION OF EMBODIMENTS:

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

The presently-disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently-disclosed subject matter.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently-disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

In some embodiments, a method and system for clarifying water can be provided, comprising flowing unclarified water through a reactor canister comprising a composition for flocculating or settling solids suspended in water. In some embodiments, the reactor canister can comprise the reactor as described in CA Patent No. 2,878,795 that issued on Sept. 22, 2015, which is incorporated by reference into this application in its entirety, and as manufactured and sold by Clearflow Group Inc. of Sherwood Park, Alberta, Canada. The composition can be a flocculant in solid or gelatinous form that can dissolve into the water. When water containing suspended solids contact the composition, the composition can dissolve thereby releasing flocculant into the water to contact the suspended solids. The suspended solids, having been contacted with the flocculant, can clump together and then settle from the water. In some embodiments, the water, after passing through the reactor, can flow into a primary settling tank where the suspended solids, now having contacted the flocculant in the reactor, can clump together and precipitate out of the water and settle in the primary settling tank. Then, the water can flow over a weir into a second settling tank where further precipitation and settling of suspended solids can occur. The water can then flow through a tubular settling media and then flow onto a trough that directs the water into an outlet chamber. From the outlet chamber, clarified water can be withdrawn.

In some embodiments, the composition can comprise a polymer or polymeric flocculant, which can further comprise a macromolecular organic component and have a high molecular weight. Suitable examples can include those described in U.S. Pat. Nos. 3,085,916 and 3,860,526, incorporated by reference herein. The proportion of the polymer in the composition can be in the range of approximately 0% to 70% by weight. The composition can further comprise any suitable alkaline earth metal soluble salt as well known to those skilled in the art, the proportion of which can be in the range of approximately 0.5% to 50% by weight. Examples of suitable soluble salts can include those disclosed in the above-mentioned patents. The balance of the composition can comprise water to make up the 100% weight.

In some embodiments, the alkaline earth metal soluble salt can be a combination of any suitable earth metal salt as well known to those skilled in the art, such as those metals that appear in columns IA or IIA of the chemical periodic table, as well known to those skilled in the art, with any suitable organic or mineral acid as well known to those skilled in the art. Suitable examples can include sulphuric acid, hydrochloric acid and nitric acid as mineral acids, whereas suitable organic acids can include acetic acid, boric acid, citric acid and formic acid. Other suitable mineral or organic acids can include those described in U.S. Pat. Nos. 3,085,916 and 3,860,526, incorporated by reference herein, the suitable selection of which can obviously be determined by those skilled in the art. The balance of the composition can comprise water to make up the 100% weight.

In some embodiments, the composition can be manufactured by first combining the polymer and the earth metal salt, both of which can be in solid granular or powder form, and then mixing them with the organic or mineral acid and water. In other embodiments, the earth metal salt can be mixed with the acid and water, and then add the polymer to the mixture.

In further embodiments, the composition can be manufactured by first combining the polymer with the alkaline earth metal soluble salt, and then adding the balance of water. In yet further embodiments, the composition can be manufactured by first mixing the alkaline earth metal soluble salt with the water, and then adding the polymer.

In any of the manufacturing methods described herein, the resultant mixtures of the components of the composition can then react with each other, which can further result in the mixture setting or curing into a solid or gelatinous form. Once the components of the composition have been mixed together, there can be a working time ranging from anywhere from approximately 2 to 10 minutes to affix the shape of the composition after which the shape composition can become set or cured.

In terms of the methods of manufacture relating to whether the last component added to the mixture to form the composition is water or the polymer, it has been observed that the choice of which can result in the polymer being more soluble or less soluble. For example, if the water is the last component added to a mixture of polymer and earth metal salt, it is observed that the resulting composition is less soluble in terms of releasing the polymer. If the polymer is the last component added to a mixture of the alkaline earth metal soluble salt, it is observed that the resulting composition is more soluble in terms of releasing the polymer. The choice of manufacture can be made in respect of the application for the composition. If the composition is to be used in a closed-loop system where liquids are re-circulated through the composition, then using a composition whose polymer is less soluble may be preferable to prevent the composition being consumed or dissolved too rapidly. If the composition is to be used in an open-loop system where liquids pass through the composition once, then using a composition whose polymer is more soluble may be preferable to introduce the polymer into the liquids at a predetermined or desired rate.

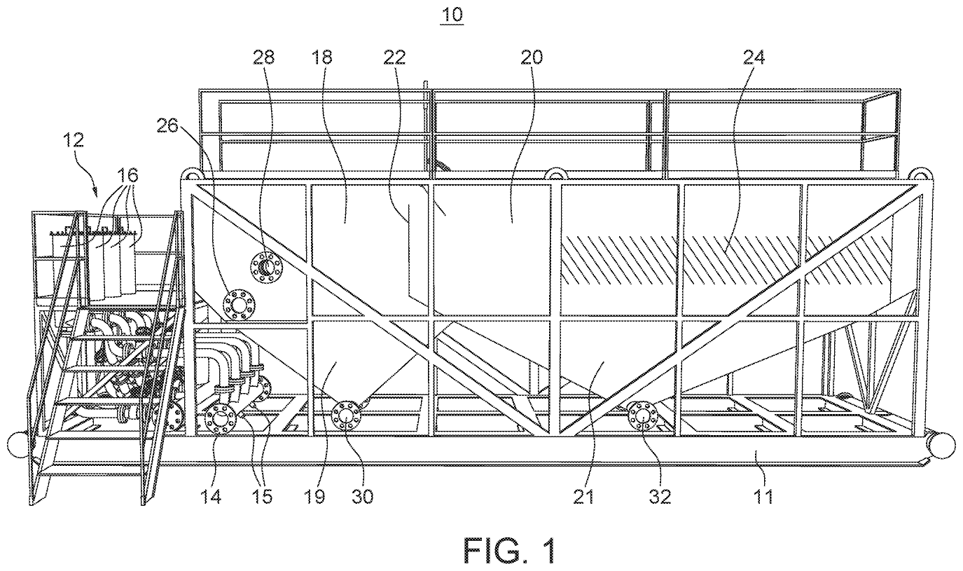

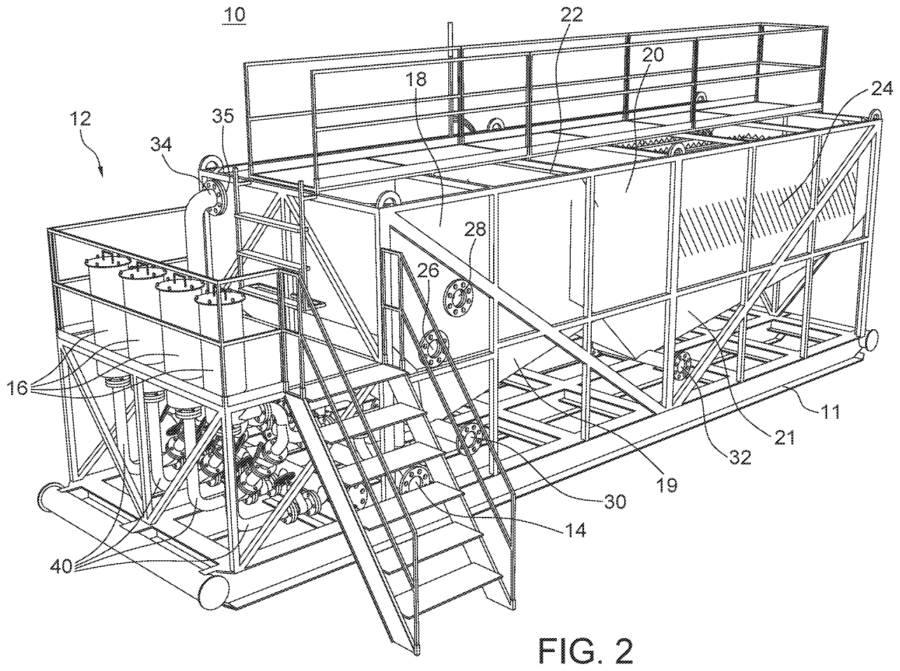

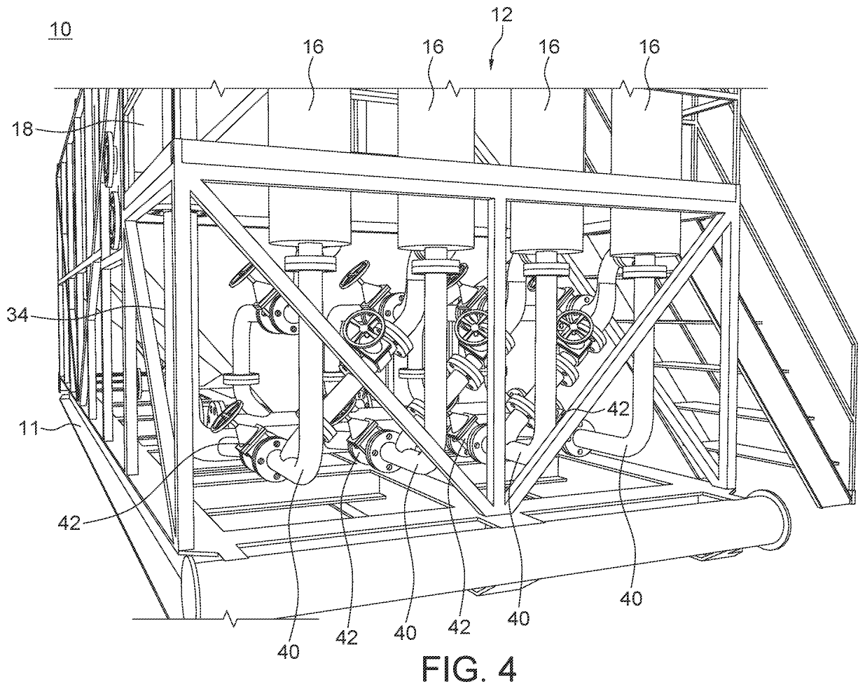

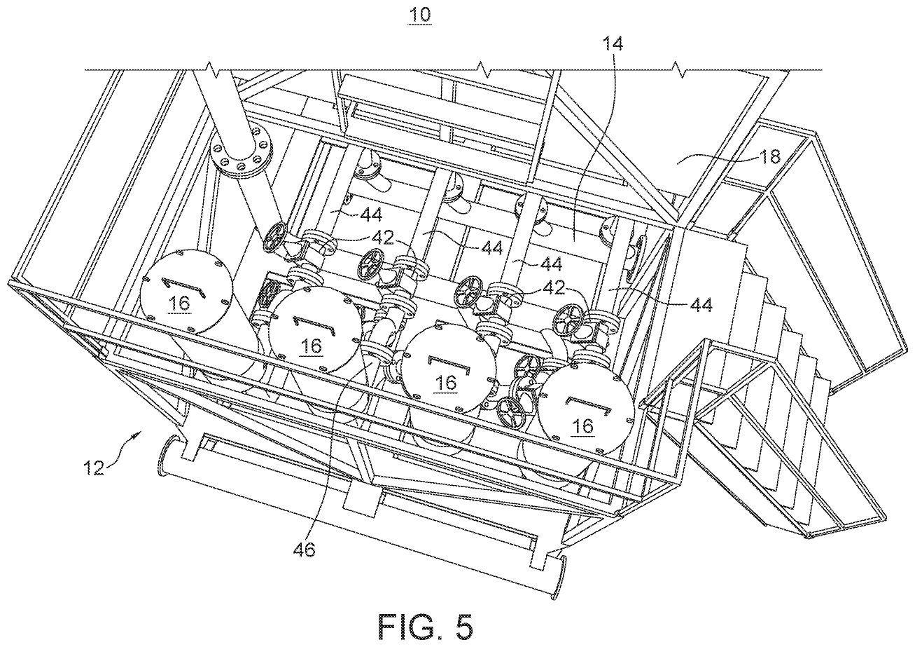

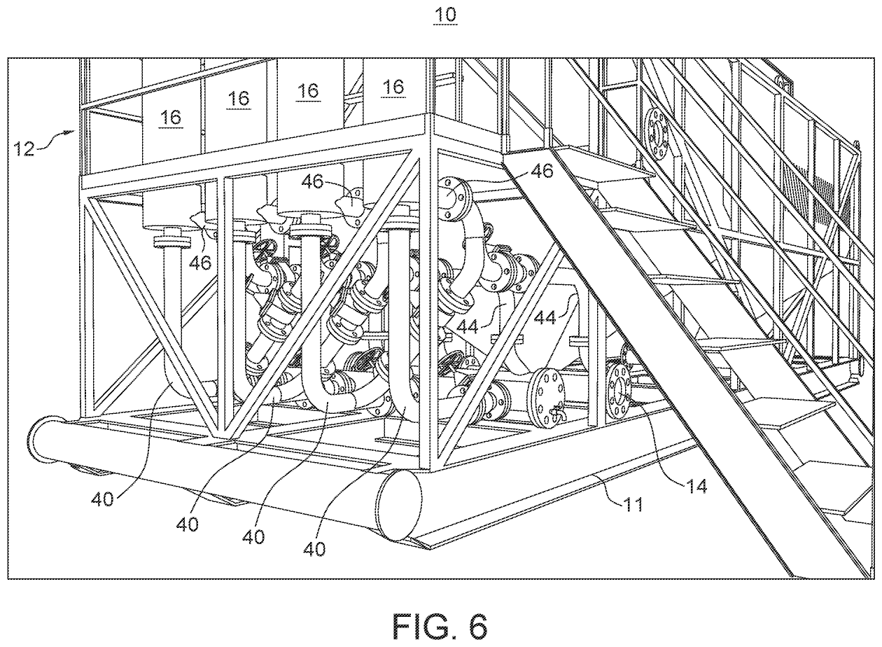

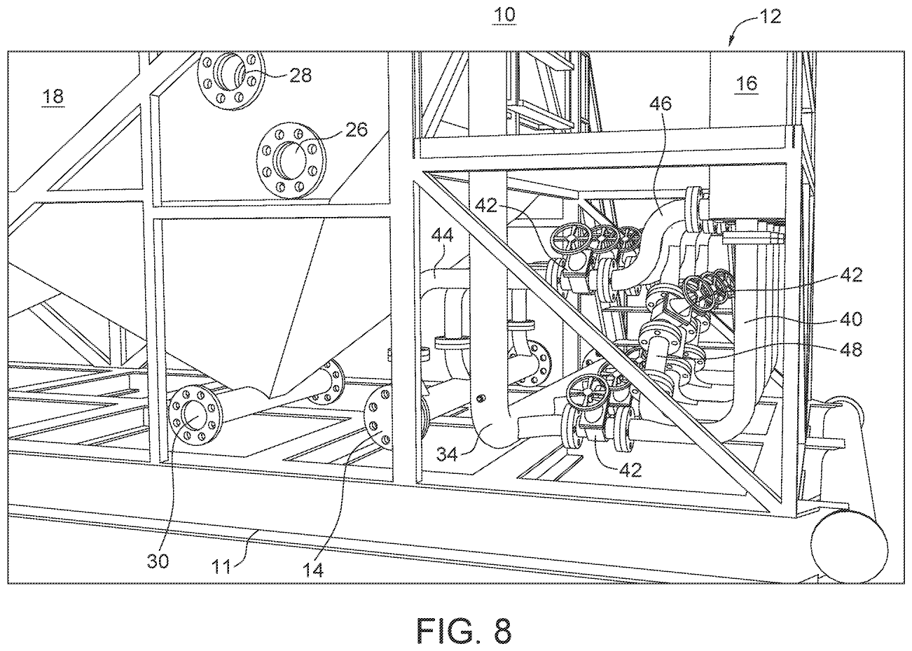

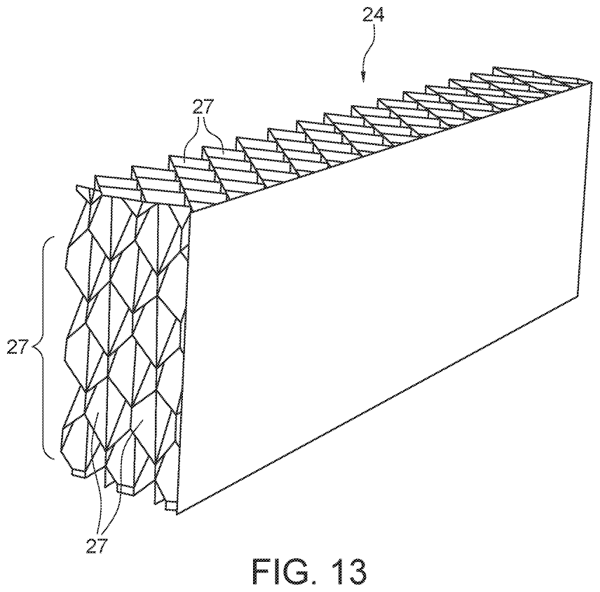

Referring to FIGS. 1 to 15, one embodiment of clarifier system 10 for use with the compositions and methods of use described herein is illustrated. In some embodiments, system 10 can comprise of skid 11 having reactor station 12, primary settling tank 18 and secondary settling tank 24 disposed thereon.

In some embodiments, water to be clarified can be fed into one or more reactors 16, each containing the flocculant composition described herein, via inlet manifold 14, which can then feed the water into an inlet of each reactor canister 16 where the water can contact the flocculant composition, as described herein, disposed therein. As the water flows through canister 16, the water mixes or is dosed with the flocculant disposed therein, thereby reducing the amount of time the water is required to spend in primary settling tank 18.

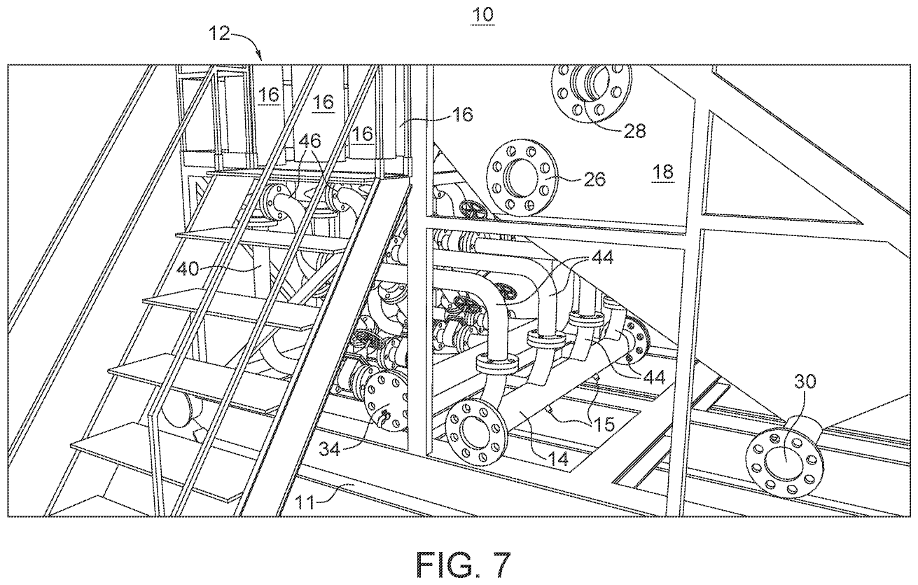

In some embodiments, inlet manifold 14 can comprised one or more injection ports 15 disposed thereon (as shown in FIGS. 1 and 7) to allow for the injection of additional chemicals as may be required, depending on the chemistry of and/or the solids suspended in the water to be clarified by system 10. In some embodiments, ports 15 can comprise ¾″ NPT nipples, as well known by those skilled in the art, which can be plugged when not required.

In some embodiments, the flocculant used in canisters 16 of system 10 can work with incoming water to be clarified having a pH in the range of 3 to 12. In many jurisdictions, environmental regulations require that water processed through a clarification that is intended for reuse purposes or release to the environment should be in a pH range of 6.5 to 8.5. In some embodiments, pH adjusting chemicals, as known by those skilled in the art, can be injected into ports 15 can be injected directly into inlet manifold 14 to mix with the water prior to entering reactor canisters 16 to balance the water to the required pH after passing through system 10.

In some embodiments, water or effluent produced from mining operations can be mixed with chemicals to aid in precipitating metals suspended in the water, as well known to those skilled in the art, by injecting said chemicals through ports 15 into inlet manifold 14.

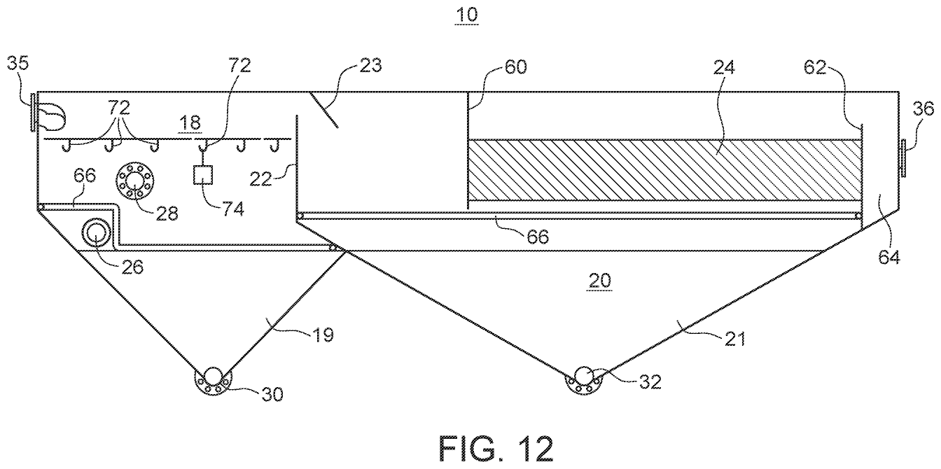

In some embodiments, additional flocculant, in the form gel blocks 74, can be added to the water in primary settling tank 18 by suspending gel blocks 74 from hooks 72 disposed on interior sidewalls of primary settling tank 18, as shown in FIG. 12. In some embodiments, gel blocks 74 can comprise a solid form of the flocculant described herein. The solid form can comprise a ready-state gel flocculant as manufactured by Clearflow Group Inc., as noted above.

After passing through reactors 16, the water can exit through pipes 40 to be collected in feed manifold 34 that can then direct the water into primary settling tank 18 via inlet 35. Once in primary settling tank 18, solids suspended in the water, now having been in contact with the flocculant composition disposed in reactors 16, can begin to collect and coalesce together to form larger particles that can precipitate out of the water and settle to the bottom of primary settling tank 18. In some embodiments, primary settling tank 18 can comprise trough 19 disposed on a lower end thereof, whereby trough 19 can be configured to collect the solids that precipitate from the water. In some embodiments, solids collected in trough 19 can be withdrawn from primary settling tank 18 via drainage port 30.

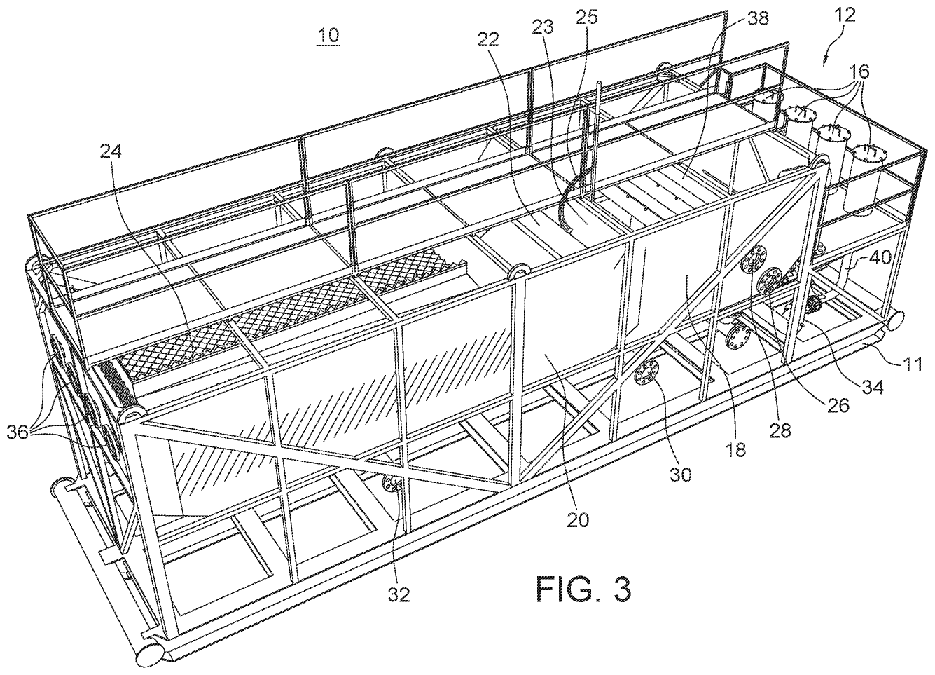

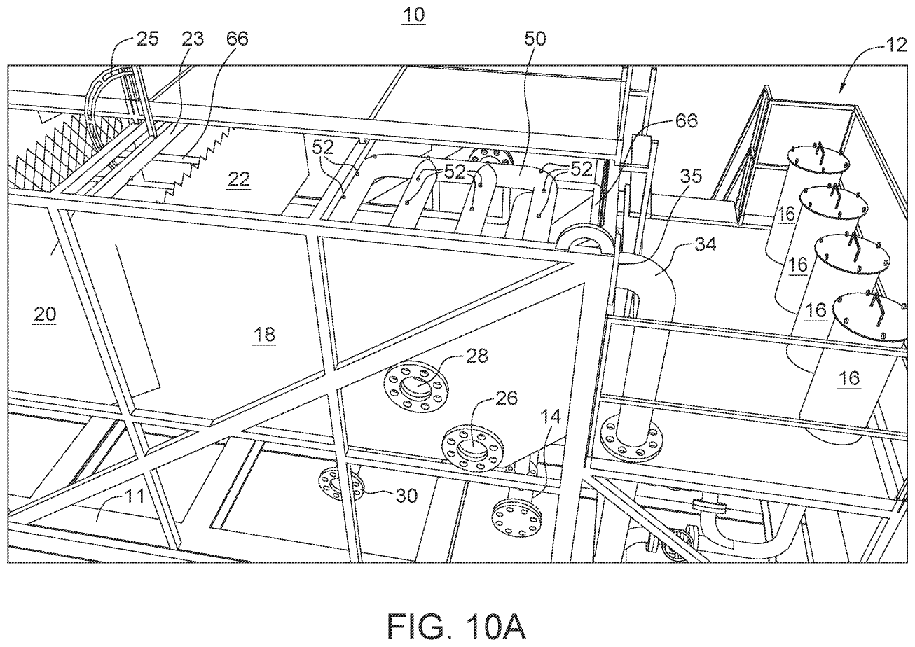

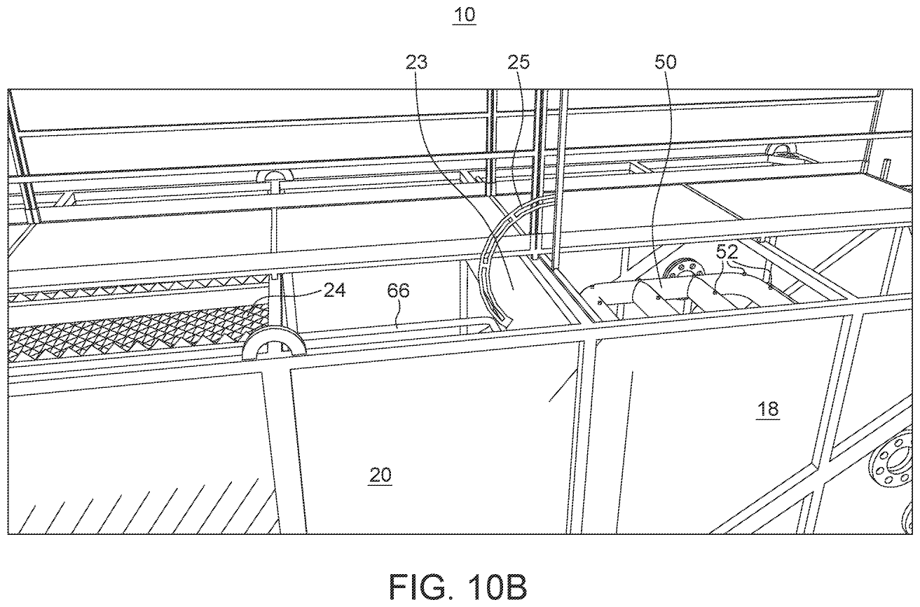

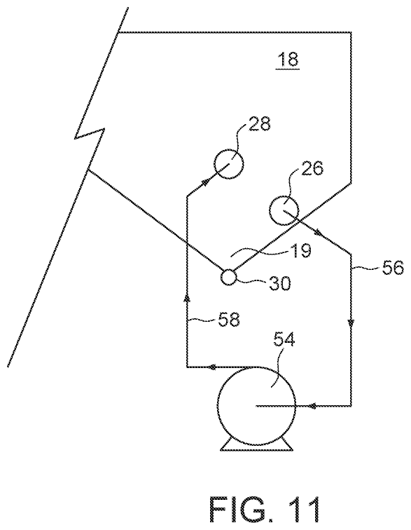

In some embodiments, the water in primary settling tank 18 can be agitated by a portion of the water being withdrawn from port 26, disposed on a sidewall of primary settling tank 18, and directed to pump 54 via conduit 56 (as shown in FIG. 11) to be pumped back to primary settling tank 18 through port 28, disposed on a sidewall of primary settling tank 18, via conduit 58 whereupon the pumped water is fed into mixing manifold 38, as shown in FIGS. 3, 10A and 10B. The pumped water can exit mixing manifold 38 via orifices 52 under force to circulate the water in primary settling tank 18. In some embodiments, conduits 56 and 58 can each be comprised of flexible or rigid pipe, hose or combination thereof.

In some embodiments, the water in primary settling tank 18, as it rises therein, can flow over weir 22 into secondary settling tank 20. The rate of the water flowing into secondary settling tank 20 can be controlled by flow vane 23, whose position can be controlled by flow vane adjuster 25, as shown in FIGS. 3, 10A and 10B.

Once the water is in secondary tank 20, any remaining solids suspended in the water can continue to collect and coalesce together to form larger particles that can precipitate out of the water and settle to the bottom of secondary settling tank 20. In some embodiments, secondary settling tank 20 can comprise trough 21 disposed on a lower end thereof, whereby trough 29 can be configured to collect the solids that precipitate from the water. In some embodiments, solids collected in trough 21 can be withdrawn from secondary settling tank 20 via drainage port 32.

In some embodiments, once the water begins to rise within secondary settling tank 20, the water can rise up through tube settling media 24, as shown in FIGS. 3, 10B and 12 to 15. In some embodiments, tube settling media 24 can increase the settling capacity of circular clarifiers and/or rectangular sedimentation basins by reducing the vertical distance a floc particle must settle before agglomerating to form larger particles. In some embodiments, tube settling media 14 can comprise a plurality tubular channels 27 sloped at an angle of about 60° relative to a horizontal plane, all disposed adjacent to each other, which can combine to form an increased effective settling area. This can provide for a particle settling depth that is significantly less than the settling depth of a conventional clarifier, reducing settling times.

In some embodiments, tube settling media 24 can capture the settleable fine floc that escapes the clarification zone beneath the tube settlers and allows the larger floc to travel to the bottom in secondary settling tank 20 in a more settleable form. The channels within tube settling media 24 can collect solids into a compact mass that can promote the precipitated solids to slide down the tube channel and then settle in trough 21.

In some embodiments, tube settling media 24 can offer an inexpensive method of upgrading existing water treatment plant clarifiers and sedimentation basins to improve performance. They can also reduce the tankage/footprint required in new installations or improve the performance of existing settling basins by reducing the solids loading on downstream filters.

In some embodiments, tube settling media 24 can be comprised of lightweight polyvinylchloride plastic that can be easily supported with minimal structures that often incorporate supports for effluent trough supports. In some embodiments, tube settling media 24 can be configured in a variety of module sizes and tube lengths to fit any tank geometry.

In some embodiments, the use of tube settling media 24 can provide a number of advantages, which can include:
a. Can be applied to new or existing clarifiers/basins of any size.
b. Clarifiers/basins equipped with tube settling media 24 can operate at 2 to 4 times the normal rate of clarifiers/basins without tube settlers.
c. Can cut coagulant dosage by up to half while maintaining a lower influent turbidity to the treatment plant filters.
d. Can result in less filter backwashing equates to significant operating cost savings for both water and electricity.
e. New installations using tube settling media 24 can be designed smaller because of increased flow capability.
f. Flow of existing water treatment plants can be increased through the addition of tube settling media 24.
g. Can increase allowable flow capacity by expanding settling capacity and increasing the solids removal rate in settling tanks.

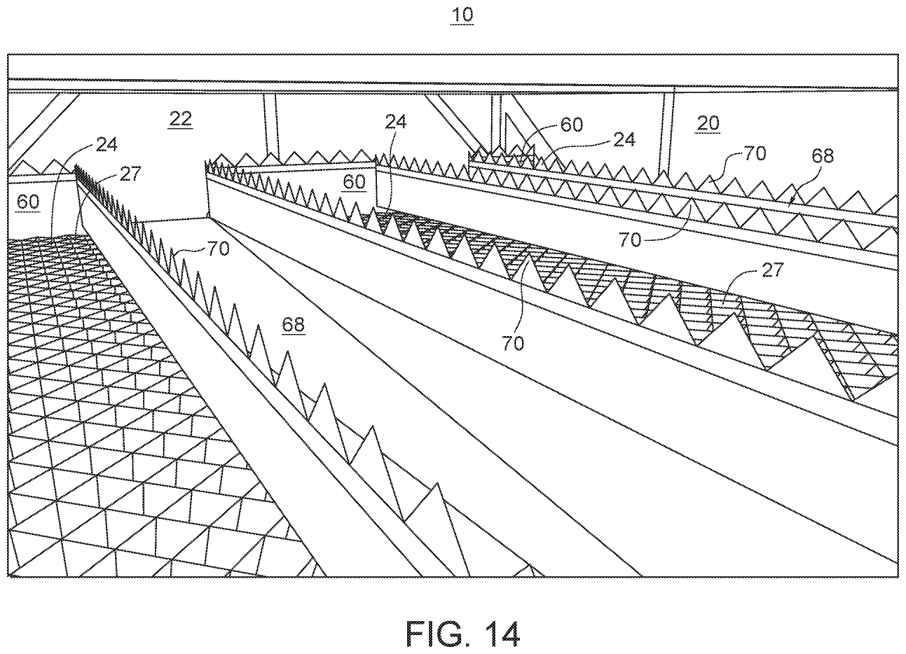

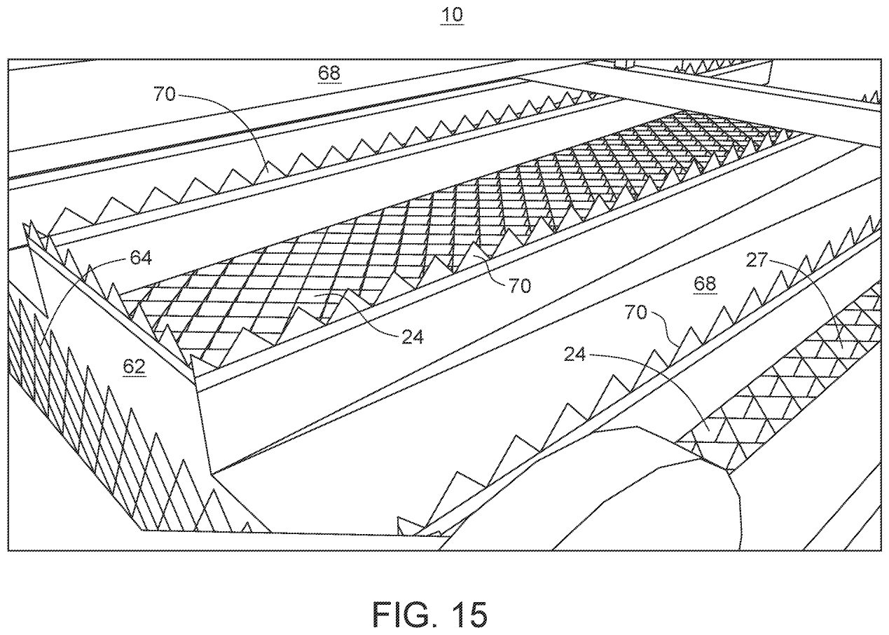

Referring to FIGS. 14 and 15, water flowing up through tube settling media 24 can flow over strainer edges 70 onto troughs 68. Strainer edges 70 can prevent any unsettled solids to flow onto troughs 68. Wall members 60 and 62 disposed at ends of tube settling media 24 can keep the water contained and directed to flow onto troughs 68.

In some embodiments, water flowing up through tube settling media 24 onto troughs 68 can be directed to flow into outlet chamber 64, as shown in FIGS. 12 and 15. Once the water has entered into outlet chamber 64, it can be considered to be clarified after having been exposed to flocculant in reactors 16 and, optionally, to flocculant gel blocks 74 disposed in primary settling tank 18, and after having the time to pass through primary settling tank 18, secondary settling tank 20 and tube settling media 24 to allow solids disposed in the water to precipitate out. The clarified water can then be withdrawn from outlet chamber 64 through outlet port 36.

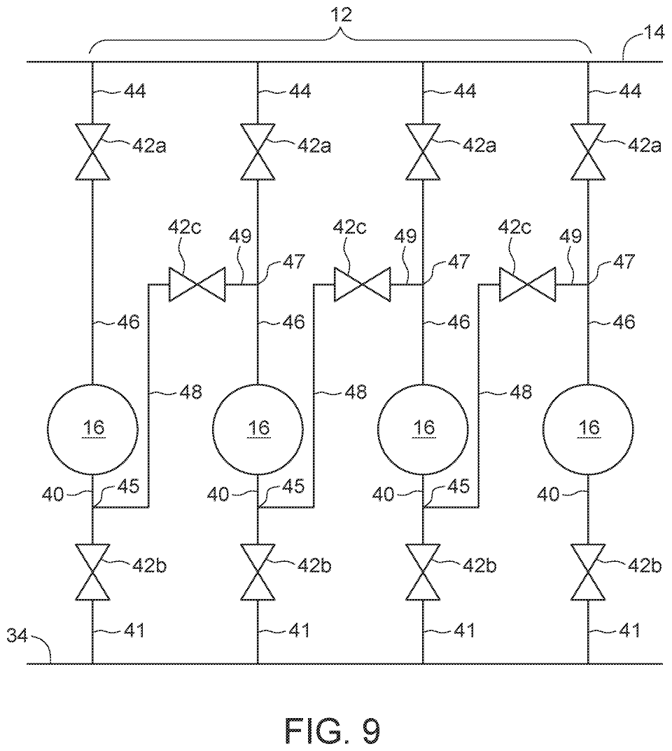

Referring to FIGS. 1 to 9, one embodiment of reactor station 12. As noted above, system 10 can comprise one or more of reactor canisters 16, wherein each canister 16 can comprise one or more of the flocculant composition described herein. Referring, in particular, to FIG. 9, in some embodiments, water to be clarified can be received through inlet manifold 14 and then directed through conduit 44, valve 42a and conduit 46 to an inlet of canister 16. Valve 42a can provide a means of controlling the flow of water into any particular canister 16. After the water passes through canister 16, it is directed from an outlet thereof to feed manifold 34 via conduit 40, valve 42b and conduit 41. Valve 42b can provide a means of controlling the flow of water from any particular canister 16.

In some embodiments, water exiting a particular canister 16 can be directed to the inlet of an adjacent canister 16 via tee connection 45, conduit 48, valve 42c, conduit 49 and tee connection 47. By configuring a plurality of canisters 16 in this manner, in some embodiments, an operator can configure reactor station 12 to operate so that water flows through a plurality of canisters 16 in a parallel or simultaneous manner where all of valves 42a and 42b are opened and all of valves 42c are closed.

In some embodiments, conduits 40, 41, 44, 46, 48 and 49 can each be comprised of flexible or rigid pipe, hose or combination thereof.

In other embodiments, reactor station 12 can be configured to operate in a series fashion where the water flows through a plurality of canisters 16 one after another by closing valve 42b associated with a first canister 16 and opening valve 42c feeding the water from the first canister 16 to the inlet of the adjacent canister 16. This configuration can be continued so that the water flows through each canister 16 before passing through to feed manifold 34.

In yet other embodiments, reactor station 12 can be configured to operate in a combination series/parallel configuration wherein at least a pair of canisters 16 are configured to operate in a series manner, wherein the remainder of the canisters 16 can operate in a parallel manner or in another pair configured to operate in a series manner. In this operating mode, one or more of canisters 16 can be “turned on” for operation, depending on the flow volume of water to be passed through system 10.

In some embodiments, by operating two canisters 16 in a series configuration, different flocculant compositions can be placed in different canisters 16 so that the water flowing therethrough can come in contact with the different flocculant compositions. In some embodiments, operating canisters 16 in series can provide a means for contacting the water with the flocculant composition over a greater time duration.

In some embodiments, the operation of valves 42a, 42b and 42c can provide a means to stop flow of the water through a particular canister 16 for maintenance purposes or to replace or add the flocculant composition to the canister.

In some embodiments, the compositions, methods and systems described herein can be used to flocculate or settle solids suspended in storm water, accumulated water at construction sites, mine wastewater and industrial tailings, and other general inflow applications such as rivers, canals, creeks, ponds and others as obvious to those skilled in the art.

In some embodiments, the compositions, methods and systems described herein can be used to flocculate or settle solids suspended in wastewater effluent, such as black water and grey water applications, and others as obvious to those skilled in the art.

In some embodiments, the compositions, methods and systems described herein can be used to flocculate or settle solids suspended in drilling fluids used in the drilling of wells and in other drilling operations as obvious to those skilled in the art. In other embodiments, the compositions, methods and systems described herein can be used to flocculate or settle solids suspended in water used in the initial drilling of wells before a first formation of oil or gas is hit with the drilling operation. In these embodiments, the water used in such drilling can be clarified and reused in the drilling process.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method for clarifying water, the method comprising:
a) passing the water through at least one reactor configured for contacting the water with a first composition, wherein the first composition comprises:
i) a first polymer comprising a high molecular weight, in a proportion of approximately 0% to 70% by weight,
ii) a first soluble salt of a group IA metal or a first soluble salt of a group IIA metal in a proportion of approximately 0.5% to 50% by weight, and
iii) water, in a proportion to make up the balance of 100% weight;
b) then passing the water from the at least one reactor into a primary settling tank;
c) then passing the water from the primary settling tank over a weir into a secondary settling tank; and
d) then passing the water from the secondary settling tank through a tubular settling media onto a trough and then flowing the water into an outlet chamber.

2. The method as set forth in claim 1, further comprising passing the water from the outlet chamber through at least one outlet port.

3. The method as set forth in claim 1, wherein the first composition is prepared by mixing the first soluble salt of a group IA metal or the first soluble salt of a group IIA metal with the water first, and then adding the first polymer thereto.

4. The method as set forth in claim 1, further contacting the water with a second composition in the primary settling tank, wherein the second composition comprises:
a) a second polymer comprising a high molecular weight, in a proportion of approximately 0% to 70% by weight;
b) a second soluble salt of a group IA metal or a second soluble salt of a group IIA metal in a proportion of approximately 0.5% to 50% by weight; and
c) water, in a proportion to make up the balance of 100% weight.

5. The method as set forth in claim 4, wherein the second composition is prepared by mixing the second soluble salt of a group IA metal or the second soluble salt of a group IIA metal with the water first, and then adding the second polymer thereto.

6. The method as set forth in claim 5, wherein the second composition comprises the first composition or a variant of the first composition.

7. The method as set forth in claim 1, further comprising passing the water through a plurality of the at least one reactor.

8. The method as set forth in claim 7, wherein the plurality of the at least one reactor is configured in one of a parallel configuration and a series configuration.

9. The method as set forth in claim 7, wherein the plurality of the at least one reactor is configured in a combination of a parallel configuration and a series configuration.

10. The method as set forth in claim 1, further comprising circulating the water in the primary settling tank through an aerating manifold.

11. The method as set forth in claim 10, wherein circulating the water comprises drawing the water from the primary settling tank with a pump, and then pumping the water into the primary settling through the aerating manifold.

12. A system for clarifying water, the system comprising:
a) at least one reactor comprising an inlet and an outlet, the at least one reactor configured for contacting the water with a first composition, wherein the first composition comprises:
i) a first polymer comprising a high molecular weight, in a proportion of approximately 0% to 70% by weight,
ii) a first soluble salt of a group IA metal or a first soluble salt of a group IIA metal in a proportion of approximately 0.5% to 50% by weight, and
iii) water, in a proportion to make up the balance of 100% weight;
b) a primary settling tank operatively coupled to the outlet of the at least one reactor;
c) a secondary settling tank;
d) a weir disposed between the primary and secondary settling tanks, wherein the water flows over the weir from the primary settling tank into the secondary settling tank; and
e) a tubular settling media disposed in the secondary settling tank, wherein the tubular settling media is configured for the water to flow through the tubular settling media from the second settling tank into an outlet chamber.

13. The system as set forth in claim 12, wherein the first composition is prepared by mixing the first soluble salt of a group IA metal or the first soluble salt of a group IIA metal with the water first, and then adding the first polymer thereto.

14. The system as set forth in claim 12, wherein the primary settling tank comprises an aerating manifold disposed therein, the aerating manifold operatively coupled to a pump configured to pump the water drawn from the primary settling tank into the aerating manifold.

15. The system as set forth in claim 12, wherein the primary settling tank is configured to suspend a second composition therein, thereby contacting the water with the second composition, wherein the second composition comprises:
a) a second polymer comprising a high molecular weight, in a proportion of approximately 0% to 70% by weight;
b) a second soluble salt of a group IA metal or a second soluble salt of a group IIA metal in a proportion of approximately 0.5% to 50% by weight; and
c) water, in a proportion to make up the balance of 100% weight.

16. The system as set forth in claim 15, wherein the second composition is prepared by mixing the second soluble salt of a group IA metal or the second soluble salt of a group IIA metal with the water first, and then adding the second polymer thereto.

17. The system as set forth in claim 16, wherein the second composition comprises the first composition or a variant of the first composition.

18. The system as set forth in claim 12, further comprising a plurality of the at least one reactor.

19. The system as set forth in claim 18, wherein the plurality of the at least one reactor is configured in one of a parallel configuration and a series configuration.

20. The system as set forth in claim 18, wherein the plurality of the at least one reactor is configured in a combination of a parallel configuration and a series configuration.
